(19) United States
(12) Patent Application Publication
(10) Pub. No.: US 2023/0407101 A1
(43) Pub. Date: Dec. 21, 2023

(54) COATING METHOD

(71) Applicant: General Electric Company, Schenectady, NY (US)

(72) Inventors: Mohandas Nayak, Bengaluru (IN); Sundeep Kumar, Bengaluru (IN); Atanu Saha, Bengaluru (IN); Julie Marie Kuhn, Cincinnati, OH (US)

(21) Appl. No.: 18/085,935

(22) Filed: Dec. 21, 2022

(30) Foreign Application Priority Data
Jun. 20, 2022 (IN) 202211035247

(51) Int. Cl. C09D 1/00; C09D 133/08; C09D 179/08; C08K 3/105

(52) U.S. Cl. CPC C09D 1/00; C09D 133/08; C23C 4/11; C08K 3/105; C09D 179/08

(57) ABSTRACT

A coating method is provided. The coating method includes applying, via electrophoretic deposition or slurry deposition, an overcoat composition on an outer surface of a thermal barrier coating system on a substrate. The overcoat composition includes a coating material comprising a plurality of particles having a particle size of less than 1000 nm. The method includes sintering the overcoat composition in the presence of one or more sintering aids to form an overcoat layer having a surface roughness of less than 1 micrometer.

### PRIORITY INFORMATION

The present application claims priority to Indian Patent Application Number 202211035247 filed on Jun. 20, 2022.

### FIELD

The present disclosure relates to a coating process, and more particularly, to a method of applying an overcoat layer on a thermal barrier coating (TBC).

### BACKGROUND

Turbomachines, such as gas turbine engines, include various components that are exposed to high temperatures and pressures during operation. For example, the combustor liners, turbine stator vanes, and the turbine blades are directly exposed to the hot combustion gases generated by the gas turbine engine. In this respect, many of components of a gas turbine engine operating in high temperature and/or pressure environments have a thermal barrier coating (TBC) applied to their exterior surface. The TBC is generally formed from a material that can withstand higher temperatures than the substrate or base material of the component on which the TBC is applied. As such, the TBC protects the component from oxidation, corrosion, and/or other damage associated with exposure to high temperatures and/or pressures.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a component including a TBC system and overcoat according to embodiments of the disclosure;

FIG. 2 is a flow chart diagram illustrating a coating method according to the embodiments of the disclosure; and

FIG. 3 is a schematic representation of a mechanism for electrophoretic deposition of a coating layer on a substrate.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, “Ln” refers to a rare earth element or a mixture of rare earth elements. More specifically, the “Ln” refers to the rare earth elements of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or mixtures thereof.

As used herein, “superalloy” refers to an alloy having improved properties with respect to conventional alloys. For example, superalloys may have excellent physical characteristics, such as but not limited to: high mechanical strength, high thermal creep deformation resistance, high surface stability, and improved resistance to corrosion or oxidation. Exemplary superalloys can include nickel-base alloys, cobalt-base alloys, or iron-base alloys. Illustrative nickel-base superalloys are designated by the trade names Inconel®, Nimonic®, Rene® (such as, Rene® 80-, Rene® 95 alloys), and Udimet®. Exemplary superalloy material includes Rene 108, CM247, Haynes alloys, Incalloy, MP98T, TMS alloys, CMSX single crystal alloys. In embodiments, superalloys include those having a high gamma prime (γ′) value. “Gamma prime” (γ′) is the primary strengthening phase in nickel-based alloys. Example high gamma prime superalloys include but are not limited to: Rene 108, N5, GTD 444, MarM 247 and IN 738.

As used herein, the term “slurry” is generally meant to embrace a solid-particle suspension in liquid.

As used herein, the terms “first”, “second”, and “third” may be used interchangeably to distinguish one component from another and are not intended to signify location or importance of the individual components.

TBCs may be applied to various combustor parts in gas turbines to protect them from the heat of combustion gases. As operation temperatures have increased, thicker TBCs are being employed. Thicker TBCs present a challenge in maintaining a smooth TBC surface that does not impact performance. The surface roughness worsens with thicker TBCs.

The present disclosure is generally related to a method of forming a smooth overcoat layer on a TBC. As noted, thicker TBCs can have a rough outer surface that captures dust and other particulate matter from incoming air, which melts and infiltrates the TBC. The rough outer surface of the TBC can also be porous further facilitating the capture of dust and other particulate matter. Such infiltration leads to spallation of the TBC and thermal compliance loss of the TBC. In areas where thermal compliance of the TBC is lost, hot spots can form due to inefficient radiative heat transfer. Accordingly, the overcoat layer provided herein includes a sintered overcoat that has a smooth surface, low roughness, to reduce hot spots. The overcoat layer is formed from a coating material having particles ranging in size from 10 nm to 1000 nm. The coating material is applied to the TBC via electrophoretic deposition or slurry spray and sintered to form an overcoat layer having a surface roughness of less than 1 micrometer. The smooth outer layer avoids residence time for dust and other particles to melt and infiltrate the TBC, thus preventing hot spots and spallation of the TBC.

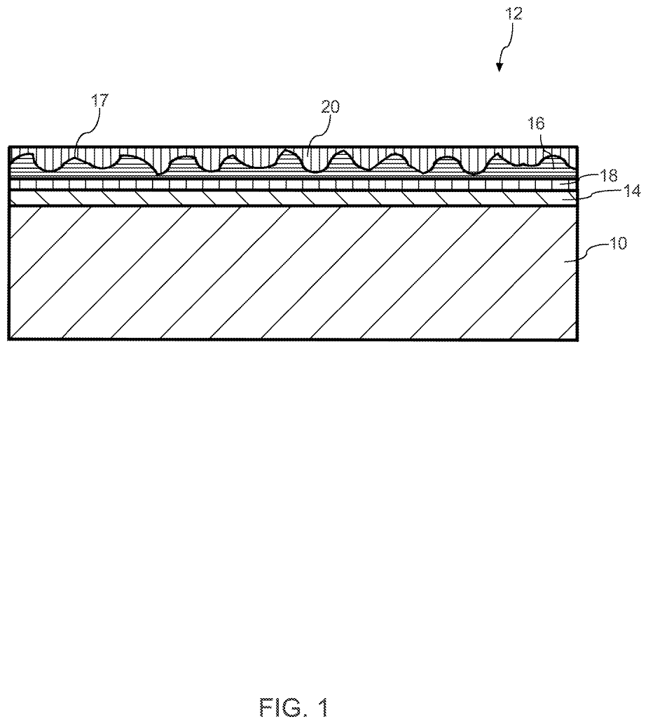

Referring now to the drawings, wherein identical numerals indicate the same elements throughout the figures, FIG. 1 is a schematic view of a component with a substrate 10 having a TBC system and overcoat layer according to embodiments of the present disclosure. The component with a substrate 10 can include any component subjected to high temperatures in gas turbine engines or land-based power generation turbine engines. Particularly such components include high and low pressure turbine nozzles and blades, shrouds, combustor liners and augmentor hardware of gas turbine engines and/or buckets for a land-based power generation turbine engine. The TBC system 12 is shown as being composed of a bond coat 14 dispose on the substrate 10 with a TBC layer 16 disposed on the bond coat 14. An overcoat layer 20 is disposed on the outer surface 17 of the TBC layer 16. As is the situation with high temperature components of gas turbine engines, the substrate can include a component formed from a superalloy material. Example superalloy materials include nickel-, cobalt-, or iron-base superalloys.

While a bond coat 14 is shown, it is to be appreciated that the use of a bond coat 14 is optional and can be omitted from the TBC system 12 as provided herein. In such embodiments devoid of a bond coat 14, the TBC layer 16 can be deposited directly on the surface of the substrate 10. When used, the bond coat 14 can be sandwiched between the substrate 10 and the TBC layer 16. The bond coat 14 may include any now known or later developed bond coat material such as but not limited to: nickel or platinum aluminides, nickel chromium aluminum yttrium (NiCrAlY) or nickel cobalt chromium aluminum yttrium (NiCoCrAlY). Bond coat 14 may have a thickness of less than 500 microns. The bond coat 14 material can include a metallic oxidation-resistant material, so as to protect the underlying substrate 10 from oxidation and enable the TBC layer 16 to better adhere to the substrate 10. Following deposition of the bond coat 14, an oxide scale 18 may form on the surface of the bond coat 14 at elevated temperatures. The oxide scale 18 provides a surface to which the TBC layer 16 more tenaciously adheres, thereby promoting the spallation resistance of the TBC layer 16.

The TBC layer 16 may generally include a ceramic thermal barrier material in one or more embodiments. For example, suitable ceramic thermal barrier coating materials may include various types of oxides, such as aluminum oxide (“alumina”), hafnium oxide (“hafnia”), or zirconium oxide (“zirconia”), in particular stabilized hafnia or stabilized zirconia, and blends including one or both of these. Examples of stabilized zirconia include without limitation yttria-stabilized zirconia, ceria-stabilized zirconia, calcia-stabilized zirconia, scandia stabilized zirconia, magnesia-stabilized zirconia, india-stabilized zirconia, ytterbia stabilized zirconia, lanthana-stabilized zirconia, gadolinia-stabilized zirconia, as well as mixtures of such stabilized zirconia. Similar stabilized hafnia compositions are known in the art and suitable for use in embodiments described herein.

In certain embodiments, the TBC layer 16 may include yttria-stabilized zirconia. Suitable yttria-stabilized zirconia may include from 1 wt. % to 20 wt. % yttria (based on the combined weight of yttria and zirconia), and more typically from 3 wt. % to 10 wt. % yttria. An example of yttria-stabilized zirconia thermal barrier coating includes 7 wt. % yttria and 93 wt. % zirconia. These types of zirconia may further include one or more of a second metal (e.g., a lanthanide, actinide, or the like) oxide, such as dysprosia, erbia, europia, gadolinia, neodymian, praseodymia, urania, and hafnia, to further reduce thermal conductivity of the thermal barrier coating material. In one or more embodiments, the TBC material may further include an additional metal oxide, such as titania and/or alumina. For example, the TBC layer 16 may be composed of 8YSZ, though higher yttria concentrations may be utilized.

Suitable ceramic TBC materials may also include pyrochlores of general formula A₂B₂O₇ where A is a metal having a valence of 3+ or 2+ (e.g., gadolinium, aluminum, cerium, lanthanum, or yttrium) and B is a metal having a valence of 4+ or (e.g., hafnium, titanium, cerium, or zirconium) where the sum of the A and B valences is 7. Representative materials of this type include gadolinium zirconate, lanthanum titanate, lanthanum zirconate, yttrium zirconate, lanthanum hafnate, cerium hafnate, and lanthanum cerate.

The TBC layer 16 is deposited on the bond coat 14 or the substrate 10 by plasma spraying, such as air plasma spraying (APS), or by physical vapor deposition (PVD). The thickness of the TBC layer 16 may depend upon the substrate 10 or the component it is deposited on. In some embodiments, the TBC layer 16 has a thickness in a range of 25 micrometer (μm) to 2000 μm. In some embodiments, the TBC layer 16 has a thickness in a range of 25 μm to 1500 μm. In some embodiments, the thickness is in a range of 25 μm to 1000 μm.

An overcoat layer 20 is deposited on the TBC layer 16. As shown, the outer surface 17 of the TBC layer 16 is rough having a roughness average (Ra) that is greater than the Ra of the overcoat layer 20. For example, in certain embodiments, the Ra of the TBC layer 16 is at least 1 μm. The Ra is measured using a stylus profilometer and optical profilometer. Ra can also be calculated in accordance with ASME B46.1. Accordingly, disposition of the overcoat layer 20 on the outer surface 17 provides a smoother outer surface for the TBC system 12 than in an absence of the overcoat layer 20. For example, the overcoat layer 20 has a surface roughness Ra of less than 1 micrometer, such as less than 0.75 micrometers, such as less than 0.5 micrometers.

Coating material utilized for the overcoat layer 20 can include rare earth oxides such as Yttrium oxide (Y₂O₃), Lathanum oxide (La₂O₃), Cerium oxide (CeO₂), Praseodymium oxide (Pr₆O₁₁), Neodymium oxide (Nd₂O₃), Samarium oxide (Sm₂O₃), Europium oxide (Eu₂O₃), Gandolinium oxide (Gd₂O₃), Terbium oxide (Tb₄O₇), Dysprosium oxide (Dy₂O₃), Holmium oxide (Ho₂O₃), Erbium oxide (Er₂O₃), Ytterbium oxide (Yb₂O₃), Lutetium oxide (Lu₂O₃), Scandium oxide (Sc₂O₃), or Thulium oxide (Tm₂O₃).

Other coating materials suitable for the overcoat layer 20, include rare earth garnets such as yttrium aluminum garnet (YAG). The rare earth garnet can include a doped YAG, such as a rare earth oxide doped YAG material. The YAG can be doped with one or more dopants that can be oxides of one or more of the following elements, La, Ce, Pr, Nd. Pm, Sm, Eu, Gd, TB, Dy, Ho, Er. Tm, Yb, Lu, and Y, Sr and Sc.

In embodiments, the coating material can include alumina and/or rare earth aluminates. For example, the one or more rare earth aluminates can include 2Gd₂O₃·Al₂O₃, 2Dy₂O₃·Al₂O₃, 2Y₂O₃·Al₂O₃, 2Er₂O₃·Al₂O₃, LaAlO₃, NdAlO₃, SmAlO₃, EuAlO₃, GdAlO₃, DyAlO₃, ErAlO₃·, Dy₃Al₅O₁₂, Y₃Al₅O₁₂, Er₃Al₅O₁₂, Lu₃Al₅O₁₂, or Yb₃Al₅O₁₂.

The coating material for the overcoat composition can also include ceramics containing zirconia (ZrO₂), stabilized or partially stabilized with yttria (Y₂O₃) (for example, 4 to 20 wt. %), MgO (for example, 4 to 24 wt. %) or CaO (for example, 4 to 8 wt. %) as a minor component. The coating material can be, preferably, yttria-stabilized zirconia (YSZ). A typical yttria-stabilized zirconia contains 6 wt. % to 30 wt. % yttria based on the total weight of zirconia and yttria, such as 6 wt. % to 20 wt. % yttria, or such as 6 wt. % to 10 wt. % yttria.

Particles of the coating material can have particle sizes less than 1000 nm, such as less than 900 nm, such as less than 800 nm, such as less than, 700 nm, such as less than 600 nm, such as less than 500 nm, such as less than 400 nm, such as less than 300 nm, such as less than 200 nm, such as less than 100 nm, such as less than 50 nm. In embodiments, the coating material includes particle sizes ranging from 10 nm to 1000 nm, such as from 50 nm to 900 nm, such as from 100 nm to 800 nm, such as from 200 nm to 700 nm, such as from 300 nm to 600 nm, such as from 400 nm to 500 nm. In certain embodiments, the particles have particle sizes ranging from 10 nm to 300 nm, such as from 30 nm to 270 nm, such as from 60 nm to 240 nm, such as from nm to 210 nm, such as from 120 nm to 180 nm. Further, in certain embodiments, at least 40 vol. % of the particles in the coating material, such as at least 50 vol. %, such as 60 vol. %, such as 70 vol. %, such as 80 vol. %, such as 90 vol. %, such as 95 vol. %, such as 99 vol. %, such as 100 vol. %, have the sizes as described herein above. Accordingly, in certain embodiments the coating material can include particles having sizes outside of those described. However, coating materials including higher volume percentages of the nanometer-sized particles can achieve smoother coatings having a lower surface roughness. Similarly, coating materials including smaller nanometer-sized particles as described can also achieve smoother coatings due to, at least in part, denser packing of particles during disposition on the TBC system 12.

Notably, in embodiments, the overcoat layer 20 is materially different from the underlying TBC layer 16. For instance, the overcoat layer may be formed from chemically different materials as compared to the underlying TBC layer 16. In such embodiments, different chemical materials are utilized in the overcoat layer 20 as compared to the TBC layer 16. In other embodiments, however, it is contemplated that the same chemical compounds are used, however, the amounts of each are different in the overcoat layer 20 as compared to the TBC layer. Further, the overcoat layer 20 can be materially different from the TBC layer 16, where the overcoat layer is formed from particles having particle sizes differing from those used to form the TBC layer 16. In embodiments where the overcoat layer 20 and TBC layer 16 are materially different, the overcoat layer 20 has a thermal conductivity that is different from the adjacent TBC layer 16. For instance, the overcoat layer 20 can have a thermal conductivity that is greater than a thermal conductivity of an adjacent TBC layer 16. The overcoat layer 20 can have a thermal conductivity ranging from 4 W/mK to 20 W/mK, such as from 8 W/mK to 14 W/mK. In such embodiments, the overcoat layer 20 better serves to conduct heat across the surface of the overcoat layer thus providing improved heat equilibration for the TBC system 12.

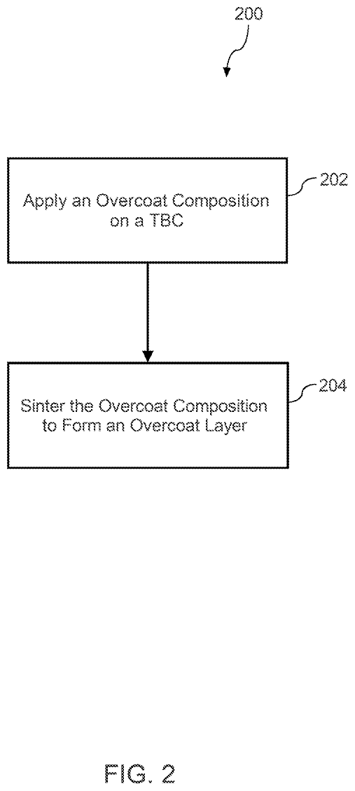

Referring now to FIG. 2, a flow chart diagram of a method 200 of coating a substrate in accordance with an exemplary aspect of the present disclosure is provided. While the method 200 of FIG. 2 may be utilized to coat one or more components of a gas turbine engine, in other exemplary aspects, the method 200 may be additionally or alternatively utilized to coat other parts or components that are subject to high heat or combustion environments.

As is depicted, the method 200 includes, at 202, applying an overcoat composition on a substrate. In embodiments, the substrate includes a surface of a component for a gas turbine engine. The gas turbine engine component can include a component in the combustion section of a gas turbine engine. Additionally, or alternatively, the component can include other gas turbine engine components such as those present in the turbine portion of the engine or those along the hot gas path of the engine. The component can include buckets for a land-based power generation turbine engine. The substrate includes a metal substrate, such as one formed from an alloy material or a superalloy material. Superalloy materials include nickel-base superalloys, cobalt-base superalloys, or iron-base superalloys. A TBC layer is disposed on the substrate. The TBC layer is applied via APS or PVD.

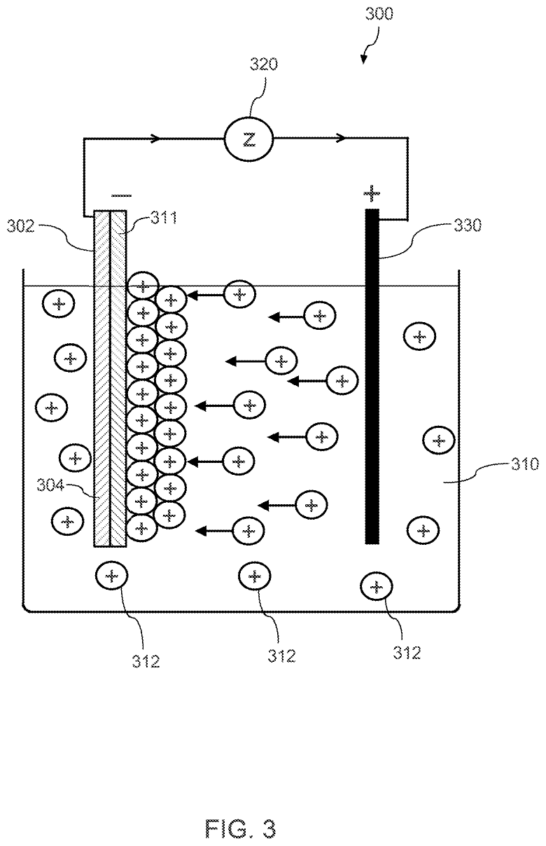

In embodiments, application of the overcoat composition can be accomplished via electrophoretic deposition. A mechanism 300 for accomplishing electrophoretic deposition is illustrated in FIG. 3. While mechanism 300 is illustrated in FIG. 3, the disclosure is not limited, and any number of devices or configurations for electrophoretic deposition can be utilized in the method provided herein. As shown, a component 302 having a surface defining a substrate 304 with a TBC system 311 disposed thereon is immersed in a suspension 310 and electrically connected to a terminal of a voltage source 320. A second electrode 330 is also submerged in the suspension 310 and connected to the voltage source 320. The suspension 310 includes particles 312 of coating material for the overcoat composition as described herein. The suspension 310 further includes a solvent for suspending the particles 312 therein. Suitable solvents can include ethanol, methanol, or other mixtures of alcohols and water. Organic solvents may also be utilized. Additional stabilizers or pH modifiers can also be added to the suspension 310. Suitable pH modifiers can include acids or bases such as nitric acid, hydrochloric acid, acetic acid, stearic acid, ammonium hydroxide, or aluminum hydroxide. The substrate 304 to be coated is biased with negative DC voltage in order to attract the particles 312 to the substrate 304. After the substrate 304 is sufficiently coated with the coating material, the DC bias is removed and the substrate 304 can be removed from the suspension 310. Optionally, the coated substrate 304 can be dried according to known drying procedures.

Referring back to FIG. 2, in other embodiments, application of the overcoat composition, at 202, can be accomplished via slurry deposition. For instance, a slurry is formed containing the coating material and a liquid carrier. Selection of a carrier will depend on various factors, such as: the solubility of the coating material and other optional additives in the carrier; the evaporation rate required during subsequent processing; the effect of the carrier on the adhesion of the slurry coating to a substrate; the carrier's ability to wet the substrate to modify the rheology of the slurry composition; as well as handling requirements; cost; availability; and environmental/safety concerns. Those of ordinary skill in the art can select the most appropriate carrier by considering these factors. Non-limiting examples of carriers include water; alcohols such as ethanol, butanol, and isopropanol; terpene and terpene-derivatives such as terpineol; halogenated hydrocarbon solvents such as methylene chloride and tetrachloromethane; and compatible mixtures of any of these substances. Other ketone solvents, such as acetylacetonate may be used. Terpene derivatives and other solvents with relatively high densities may be preferred, in view of their ability to readily maintain the metal particles in suspension. Lower density solvents are sometimes used with thickeners or anti-settling agents.

The amount of liquid carrier employed is usually the minimum amount sufficient to keep the solid components of the slurry in suspension. Amounts greater than that level may be used to adjust the viscosity of the slurry composition, depending on the technique used to apply the composition to a substrate. In general, the liquid carrier will comprise 30% by volume to 70% by volume of the entire slurry composition. Additional amounts of the liquid carrier may be used to adjust slurry viscosity prior to application of the coating.

The slurry of the coating material may also contain one or more binders and other additives. Non-limiting examples of suitable binders include poly(vinyl butyral), polyethylene oxide, and various acrylics, phosphates and chromates, as well as other water-based or solvent-based organic materials. The amount of binder present will vary considerably, but it is usually in the range of 0.1 wt. % to 10 wt. % of the entire slurry composition.

Other components that can be included in the slurry include thickening agents, dispersants (which break up flocs in a slurry); deflocculants, anti-settling agents, plasticizers, emollients, lubricants, solvents, surfactants and anti-foam agents. In general, lubricants, thickeners, or emollients may each be used at a level in the range of 0.01 wt. % to 10 wt. %, such as 0.1 wt. % to 2.0 wt. %, based on the weight of the entire slurry composition. Suitable dispersants include polyethyleneimide, ammonium polyacrylate, or one or more carboxylic acids. Those skilled in the art can determine the most effective level for any of the other additives.

The slurry may be applied to the TBC on the substrate, as shown by FIG. 1, by a variety of techniques known in the art. For example, the slurry can be slip-cast, brush-painted, dipped, sprayed, flow-coated, roll-coated, or spun-coated onto the substrate surface.

Specifically, spraying (such as, air spraying or airless spraying) can be utilized to apply the slurry onto the substrate. The viscosity of the slurry for spraying can be adjusted by varying the amount of liquid carrier used. Spraying equipment and parameters for this technique are known in the art. One example of an air-spray gun is the Paasche 62 sprayer, which operates at 35-40 psi, and forms a 1-2 inch (2.5-5.1 cm) spray-fan pattern, when the spray gun is kept at 5-12 inches (12-30 cm) from the substrate (stand-off distance). A wide variety of paint sprayers can be used. The slurry may be applied in multiple passes (such as, back and forth) of the spray gun.

Slurry deposition can take place at ambient temperatures ranging from to 30° C., such as 20° C. to 25° C. Slurry deposition can also take place in cycles generally including slurry formation, slurry application, drying and sintering, with optional masking, leveling, sintering aid infiltration, mask removal, and binder burnout steps as needed. Those skilled in the art will understand that slurries of varying compositions can be used to make layers of varying compositions and that multiple slurry deposition cycles can be used to build up the total thickness of a particular layer.

At 204, the overcoat composition is sintered in the presence of one or more sintering aids to form an overcoat layer. Sintering can serve to simultaneously densify and impart strength to the overcoat layer. Sintering can be carried out using a conventional furnace, or by using such methods as microwave sintering, laser sintering, infrared sintering, and the like. In embodiments, sintering of the overcoat composition may be achieved in situ.

Sintering can be accomplished by heating the substrate at a rate of 1° C./min to 15° C./min to a temperature of 1100° C. to 1700° C. and holding the substrate at that temperature for from 0 to 24 hours. In another embodiment, sintering can be accomplished by heating the coated substrate at a rate of 5° C./min to 15° C./min to a temperature of 1300° C. to 1375° C. and holding the substrate at that temperature for from 0 to 24 hours. In another embodiment, sintering can occur rapidly by placing the substrate into a furnace heated to a temperature of 1000° C. to 1400° C.

Sintering may be carried out in an ambient air atmosphere, or in an inert gas atmosphere where the inert gas is selected from hydrogen, a noble gas such as helium, neon, argon, krypton, xenon, or mixtures thereof.

As noted, one or more sintering aids are present during sintering of the coated substrate. Sintering aids can be applied to the overcoat material composition prior to sintering, can be included in the suspension or slurry, or can be present in the ambient environment during sintering. In embodiments, slurries of coating material described can include various sintering aids. In some embodiments, there can be from wt. % to 25 wt. %, and in some embodiments from 0.01 wt. % to 25 wt. %, of a sintering aid. Suitable sintering aids include iron oxide, gallium oxide, aluminum oxide, nickel oxide, titanium oxide, boron oxide, and alkaline earth oxides; carbonyl iron; iron metal, aluminum metal, boron, nickel metal, hydroxides including iron hydroxide, gallium hydroxide, aluminum hydroxide, nickel hydroxide, titanium hydroxide, alkaline earth hydroxides; carbonates including iron carbonate, gallium carbonate, aluminum carbonate, nickel carbonate, boron carbonate, and alkaline earth carbonates; oxalates including iron oxalate, gallium oxalate, aluminum oxalate, nickel oxalate, titanium oxalate; and “water soluble salts” including water soluble iron salts, water soluble gallium salts, water soluble aluminum salts, water soluble nickel salts, water titanium salts, water soluble boron salts, and water soluble alkaline earth salts.

As noted, the overcoat layer as described herein provides a TBC system having a smoother outer coating that avoids residence time for dust to melt and infiltrate the TBC system, which can prevent spallation and degradation of the TBC system. Further, the overcoat layer provided can further reduce heat transfer due to radiative transfer. Such aspects allow for longer service life, time on wing, etc.

Further aspects are provided by the subject matter of the following clauses:

A method, comprising: applying an overcoat composition on an outer surface of a thermal barrier coating system on a substrate, the overcoat composition comprising a coating material comprising a plurality of particles having a particle size of less than 1000 nm; and sintering the overcoat composition in the presence of one or more sintering aids to form an overcoat layer having a surface roughness of less than 1 micrometer.

The method of any preceding clause, wherein the coating material is applied via electrophoretic deposition or slurry deposition.

The method of any preceding clause, wherein the particle size is from 10 nm to 1000 nm.

The method of any preceding clause, wherein the coating material comprises samarium oxide, yttria-stabilized zirconia, one or more rare earth garnets, alumina, one or more rare earth aluminates, or combinations thereof.

The method of any preceding clause, wherein the one or more rare earth aluminates comprises 2Gd₂O₃·Al₂O₃, 2Dy₂O₃·Al₂O₃, 2Y₂O₃·Al₂O₃, 2Er₂O₃·Al₂O₃, LaAlO₃, NdAlO₃, SmAlO₃, EuAlO₃, GdAlO₃, DyAlO₃, ErAlO₃, Dy₃Al₅O₁₂, Y₃Al₅O₁₂, Er₃Al₅O₁₂, Yb₃Al₅O₁₂, or Lu₃Al₅O₁₂.

The method of any preceding clause, wherein the one or more rare earth garnets comprises yttrium aluminum garnet.

The method of any preceding clause, wherein the overcoat composition is formulated as a slurry comprising one or more dispersants comprising polyethyleneimide, ammonium polyacrylate, one or more carboxylic acids, or combinations thereof.

The method of any preceding clause, wherein the overcoat composition is formulated as a slurry comprising one or more solvents comprising water, ethanol, isopropanol, butanol, acetylacetonate, or combinations thereof.

The method of any preceding clause, wherein the one or more sintering aids comprises iron oxide, gallium oxide, aluminum oxide, nickel oxide, titanium oxide, boron oxide, alkaline earth oxides, carbonyl iron, iron metal, aluminum metal, boron, nickel metal, iron hydroxide, gallium hydroxide, aluminum hydroxide, nickel hydroxide, titanium hydroxide, alkaline earth hydroxides, iron carbonate, gallium carbonate, aluminum carbonate, nickel carbonate, boron carbonate, alkaline earth carbonates, iron oxalate, gallium oxalate, aluminum oxalate, nickel oxalate, titanium oxalate, solvent soluble iron salts, solvent soluble gallium salts, solvent soluble aluminum salts, solvent soluble nickel salts, solvent titanium salts, solvent soluble boron salts, solvent soluble alkaline earth salts, or combinations thereof.

The method of any preceding clause, wherein a composition of the overcoat layer is different from a composition of the adjacent layer of the thermal barrier coating system.

The method of any preceding clause, wherein the overcoat composition is applied at a temperature of 15° C. to 30° C.

The method of any preceding clause, wherein sintering the overcoat composition comprises heating the overcoat composition at a rate of at least 1° C./min to 15° C./min to a sintering temperature of 1000° C. to 1400° C. and holding the substrate at the sintering temperature for 0 to 24 hours.

The method of any preceding clause, wherein the surface roughness is less than 0.50 micrometers.

The method of any preceding clause, wherein the overcoat layer has a first thermal conductivity that is greater than a second thermal conductivity of an adjacent layer of the thermal barrier coating system.

The method of any preceding clause, wherein the first thermal conductivity is from 4 W/mK to 20 W/mK.

The method of any preceding clause, wherein the substrate comprises a metal substrate.

The method of any preceding clause, wherein the metal substrate comprises a nickel-base superalloy material, a cobalt-base superalloy material, or an iron-base superalloy material.

The method of any preceding clause, further comprising applying the thermal barrier coating system on the substrate via air plasma spray or physical vapor deposition.

The method of any preceding clause, wherein the thermal barrier coating system comprises a thermal barrier coating layer and a bond coat layer sandwiched between the substrate and the thermal barrier coating layer.

The method of any preceding clause, wherein the thermal barrier coating layer is the adjacent layer of the thermal barrier coating system.

The method of any preceding clause, wherein the substrate is a gas turbine engine component.

The method of any preceding clause, wherein the gas turbine engine component comprises a combustion section component.

An article comprising: a substrate; at least a thermal barrier coating layer on the substrate; a sintered overcoat on the thermal barrier coating layer, the sintered overcoat comprising a coating material having a plurality of particles with a particle size of less than 1000 nm, wherein the sintered overcoat has a surface roughness of less than 1 micrometer.

The article of any preceding clause, wherein the coating material is applied via electrophoretic deposition or slurry deposition.

The article of any preceding clause, wherein the particle size is from 10 nm to 1000 nm.

The article of any preceding clause, wherein the coating material comprises samarium oxide, yttria-stabilized zirconia, one or more rare earth garnets, alumina, one or more rare earth aluminates, or combinations thereof.

The article of any preceding clause, wherein the one or more rare earth aluminates comprises 2Gd₂O₃·Al₂O₃, 2Dy₂O₃·Al₂O₃, 2Y₂O₃·Al₂O₃, 2Er₂O₃·Al₂O₃, LaAlO₃, NdAlO₃, SmAlO₃, EuAlO₃, GdAlO₃, DyAlO₃, ErAlO₃, Dy₃Al₅O₁₂, Y₃Al₅O₁₂, Er₃Al₅O₁₂, Yb₃Al₅O₁₂, or Lu₃Al₅O₁₂.

The article of any preceding clause, wherein the one or more rare earth garnets comprises yttrium aluminum garnet.

The article of any preceding clause, wherein a chemical composition of the overcoat layer is different from a chemical composition of the adjacent layer of the thermal barrier coating system.

The article of any preceding clause, wherein the surface roughness is less than 0.50 micrometers.

The article of any preceding clause, wherein the overcoat layer has a first thermal conductivity that is greater than a second thermal conductivity of an adjacent layer of the thermal barrier coating system.

The article of any preceding clause, wherein the first thermal conductivity is from 4 W/mK to 20 W/mK.

The article of any preceding clause, wherein the substrate comprises a metal substrate.

The article of any preceding clause, wherein the metal substrate comprises a nickel-base superalloy material, a cobalt-base superalloy material, or an iron-base superalloy material.

The article of any preceding clause, wherein the thermal barrier coating system is applied via air plasma spray or physical vapor deposition.

The article of any preceding clause, wherein the thermal barrier coating system comprises a thermal barrier coating layer and a bond coat layer sandwiched between the substrate and the thermal barrier coating layer.

The article of any preceding clause, wherein thermal barrier coating layer is the adjacent layer of the thermal barrier coating system.

The article of any preceding clause, wherein the article is a gas turbine engine component.

The article of any preceding clause, wherein the gas turbine engine component comprises a combustion section component.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method, comprising:
applying an overcoat composition directly on an outer surface of a thermal barrier coating of a thermal barrier coating system on a substrate, the overcoat composition comprising a coating material comprising a plurality of particles, substantially all of the particles having a particle size of less than 1000 nm; and
sintering the overcoat composition in the presence of one or more sintering aids to form an overcoat layer having a surface roughness (Ra) of less than 1 micrometer.

2. The method of claim 1, wherein the overcoat composition is applied via electrophoretic deposition.

3. The method of claim 1, wherein the particle size is from 10 nm up to, but not including, 1000 nm.

4. The method of claim 1, wherein the coating material comprises samarium oxide, yttria-stabilized zirconia, one or more rare earth garnets, alumina, one or more rare earth aluminates, or combinations thereof.

5. The method of claim 4, wherein the one or more rare earth aluminates comprises 2Gd₂O₃·Al₂O₃, 2Dy₂O₃·Al₂O₃, 2Y₂O₃·Al₂O₃, 2Er₂O₃·Al₂O₃, LaAlO₃, NdAlO₃, SmAlO₃, EuAlO₃, GdAlO₃, DyAlO₃, ErAlO₃, Dy₃Al₅O₁₂, Y₃Al₅O₁₂, Er₃Al₅O₁₂, Yb₃Al₅O₁₂, or Lu₃Al₅O₁₂.

6. The method of claim 4, wherein the one or more rare earth garnets comprises yttrium aluminum garnet.

7. The method of claim 1, wherein the overcoat composition is formulated as a slurry comprising one or more dispersants comprising polyethyleneimide, ammonium polyacrylate, one or more carboxylic acids, or combinations thereof.

8. The method of claim 1, wherein the overcoat composition is formulated as a slurry comprising one or more solvents comprising water, ethanol, isopropanol, butanol, acetylacetonate, or combinations thereof.

9. The method of claim 1, wherein the one or more sintering aids comprises iron oxide, gallium oxide, aluminum oxide, nickel oxide, titanium oxide, boron oxide, alkaline earth oxides, carbonyl iron, iron metal, aluminum metal, boron, nickel metal, iron hydroxide, gallium hydroxide, aluminum hydroxide, nickel hydroxide, titanium hydroxide, alkaline earth hydroxides, iron carbonate, gallium carbonate, aluminum carbonate, nickel carbonate, boron carbonate, alkaline earth carbonates, iron oxalate, gallium oxalate, aluminum oxalate, nickel oxalate, titanium oxalate, solvent soluble iron salts, solvent soluble gallium salts, solvent soluble aluminum salts, solvent soluble nickel salts, solvent titanium salts, solvent soluble boron salts, solvent soluble alkaline earth salts, or combinations thereof.

10. The method of claim 1, wherein a chemical composition of the overcoat layer is different from a chemical composition of an adjacent layer of the thermal barrier coating system.

11. The method of claim 1, wherein the overcoat composition is applied at a temperature of 15° C. to 30° C.

12. The method of claim 1, wherein sintering the overcoat composition comprises heating the overcoat composition at a rate of at least 1° C./min to 15° C./min to a sintering temperature of 1000° C. to 1400° C. and holding the substrate at the sintering temperature for 0 to 24 hours.

13. The method of claim 1, wherein the surface roughness is less than 0.50 micrometers.

14. The method of claim 1, wherein the overcoat layer has a first thermal conductivity that is greater than a second thermal conductivity of an adjacent layer of the thermal barrier coating system.

15. The method of claim 14, wherein the first thermal conductivity is from 4 W/mK to 20 W/mK.

16. The method of claim 1, wherein the substrate comprises a metal substrate.

17. The method of claim 16, wherein the metal substrate comprises a nickel-base superalloy material, a cobalt-base superalloy material, or an iron-base superalloy material.

18. The method of claim 1, further comprising applying the thermal barrier coating system on the substrate via air plasma spray or physical vapor deposition.

19. The method of claim 1, wherein the thermal barrier coating system comprises a thermal barrier coating layer and a bond coat layer sandwiched between the substrate and the thermal barrier coating layer.

20. The method of claim 1, wherein the substrate is a gas turbine engine component.
